(19) United States
(12) Patent Application Publication
(10) Pub. No.: US 2002/0147866 A1
(43) Pub. Date: Oct. 10, 2002

(54) Data transmission system

(75) Inventor: Werner Agne, Rothenbach (DE)

Correspondence Address: BAKER BOTTS LLP, 44TH FLOOR, 30 ROCKEFELLER PLAZA, NEW YORK, NY, 10112-4498, US

(73) Assignee: SIEMENS AG.

(21) Appl. No.: 09/892,414

(22) Filed: Jun. 27, 2001

(30) Foreign Application Priority Data
Apr. 9, 2001 (DE) 10117748.8

(51) Int. Cl. G06F 13/00

(52) U.S. Cl. 710/100

(57) ABSTRACT

The present invention relates to a data transmission system for machine tools production machines, and robots, having with a central data line, from which there branch off stub-like data lines in which signal processing units are arranged, having transmitting and receiving elements which respectively pass on data in a serial form. A return from the last to the first signal processing unit respectively of the stub-like data line makes it possible to significantly increase the flexibility and availability of the machine tools, production machines and robots.

The invention relates to a data transmission system for machine tools and production machines, and also robots, with a central data line, from which there branch off stub-like data lines in which signal processing units are arranged, having transmitting and receiving elements which respectively pass on data in a serial form.

It is generally customary to equip machine tools and production machines, and also robots, with data transmission systems in order to make process communication possible. EP 0 129 853 B1 discloses robot cells interlinked in a cooperating manner and having drives. Each robot cell has a device to transmit or receive information at least to and from a neighboring robot cell on a transmission medium. Each drive controller determines, on the basis of the information received from the transmission medium, the required movements of its own robot cell.

The object of the invention is to increase the flexibility and availability of a serial data transmission system, and the associated machine components, and consequently the availability of the overall technical process in connection with the data transmission system.

### SUMMARY OF THE INVENTION

According to the invention, this object is achieved by a return from the last to the first signal processing unit respectively of a stub-like data line. In the event of failure of a signal processing unit in a stub-like data line, the communication to the units downstream of the failed signal processing unit is disrupted. This disruption in communication is preferably avoided by the construction of an annular communication structure by a return of the data line.

A first preferred design of the present invention is characterized in that a return from the last to the first signal processing unit respectively of the central data line is provided. In the event of failure of a signal processing unit in the central data line, all downstream signal processing units are disrupted. This is disadvantageous in particular since additionally existing stub data lines also fail completely. This state is consequently counteracted in an advantageous way by the construction of an annular communication structure of the central data line.

A further preferred design of the present invention is characterized in that the first signal processing unit of an annular communication structure is designed as a distributor node with a group control function. The distributor node with a group control function can issue decentrally binding guidelines.

A further preferred design of the present invention is characterized in that a substitute distributor node is incorporated in an annular communication structure. As a result, in the event of failure of the distributor node, the operation of further signal processing units of the annular communication structure can be maintained in a particularly advantageous way. The substitute distributor node in this case takes over the function of the distributor node with a group control function.

A further preferred design of the present invention is characterized in that a field bus system is provided as the data transmission system. With a field bus system, industrial requirements, such as for example high availability, can be met.

A further preferred design of the present invention is characterized in that an Ethernet is provided as the data transmission system. The use of an Ethernet makes it possible to resort to numerous developments from the PC sector.

### DRAWINGS

Exemplary embodiments of the invention are explained in more detail below and represented in the drawings, in which:

FIG. 1 shows a structure of a central data line, from which there are branch off stub-like data lines in which signal processing units are arranged;

FIG. 2 shows a data transmission structure with returns for stub-like data lines and for a central data line; and

FIG. 3 shows a data transmission structure with returns for stub-like data lines and a central data line with distributor nodes and substitute distributor nodes.

### DETAILED DESCRIPTION OF THE DRAWINGS

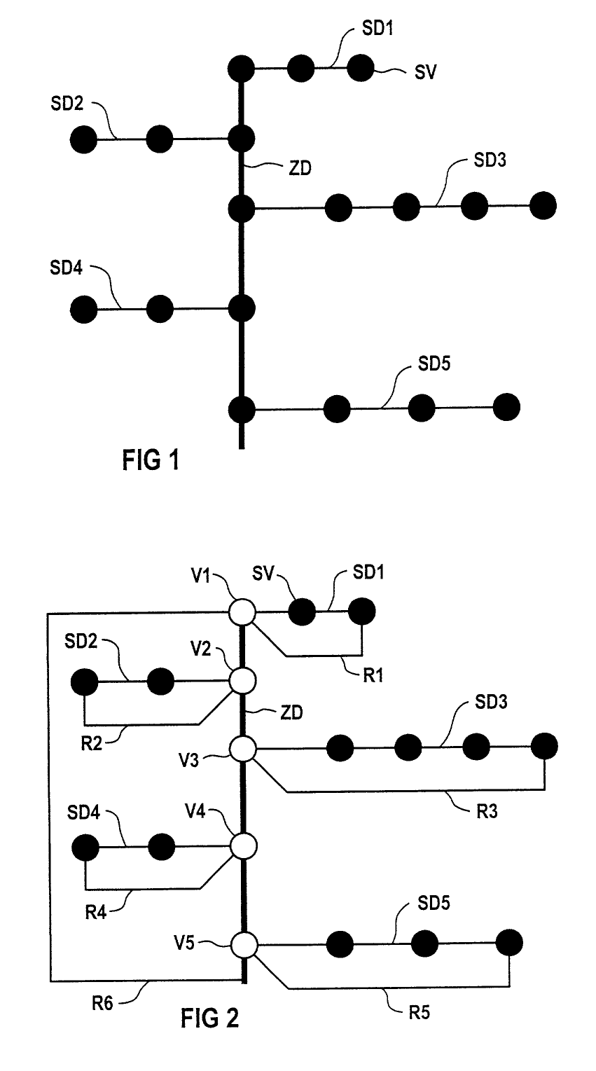

In FIG. 1, a data transmission system is shown in the form of a structural overview. On a central data line ZD there are signal processing units, from which stub-like data lines SD1 to SD5 branch off. This communication structure may be, for example, a production machine, in which at least one electric drive is assigned to each signal processing unit SV. In the event of a failure of a signal processing unit SV in a stub-like data line SD1 to SD5, all the downstream signal processing units SV will similarly fail. The serial data communication is disrupted and may not be routed to signal processing units SV which still may be intact. The failure of one signal processing unit SV on the central data line ZD will lead to all the downstream stub-like data lines SD1 to SD5 being cut off from communication.

FIG. 2 illustrates a data system structure with returns R1 to R6 for stub-like data lines SD1 to SD5 and a central data line ZD with distributor nodes V1 to V5. A return R1 to R6 is provided from the last to the first signal processing unit SV, respectively of a stub-like data line SD1 to SD5 and the central data line ZD. The construction of an annular communication structure makes it possible in the event of failure of one signal processing unit SV for the communication to be taken further in the form of an open ring around the failed signal processing unit SV. These measures have the effect of increasing the availability of the data communication system of a machine tool or production machine, and also of a robot system.

The failure of the data communication system is explained in more detail below in the context of a printing machine. In a printing machine, a rotary press has a plurality of drives, which in each case have a signal processing unit SV. If a drive or a signal processing unit SV fails, it may be that the paper web to be printed on can be directed over the still available drives by converting the machine. The communication structure can be used to allocate the individual drives of the printing or transporting rollers a specific function, for example, synchronizing the web running speed. Furthermore, information can also be transmitted from position sensors or other measuring or information sensors to the signal processing unit SV. This information is then available at the distributor node V1 to V5 in the system.

For the operators of a printing machine, the availability of a rotary printing press may be of vital significance. The printing operation may be locked into a very time-critical regime of distribution logistics, as is the case for example when printing daily newspapers. Every major interruption leads to a time delay and ultimately entails considerable financial losses. Safeguarding the availability of the machine and increasing flexibility is ensured by the present invention.

In FIG. 2, distributor nodes V1 to V5 are located on the central data line ZD. The distributor nodes V1 to V5 are formed with a group control function and prescribe specific behavior patterns to the signal processing units SV at a hierarchically subordinate level in the group in the communication structure. For example, the distributor node V1 to V5 with a group control function can prescribe a signal to which all the subordinate signal processing units SV have to synchronize themselves. The group control function property of a signal processing unit SV is identified in FIG. 2 by an open circle. The central data line ZD is similarly equipped with a return R6. Consequently, a failed distributor node V1 to V5 does not lead to complete failure of the downstream communication structure.

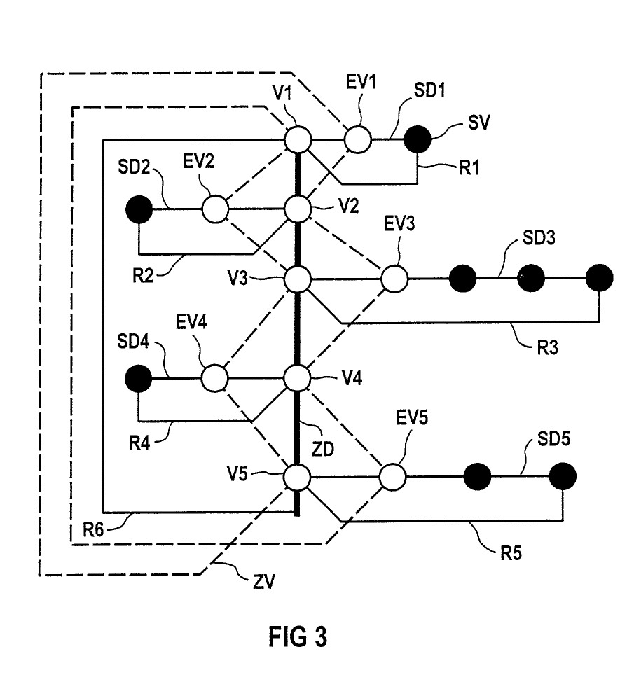

In FIG. 3, substitute distributor nodes EV1 to EV5 are arranged in the annular communication substructure behind the distributor nodes V1 to V5. The substitute distributor nodes EV1 to EV5 are connected via communication connections to the respectively upstream and downstream distributor nodes V1 to V5 with a group control function. These additional connections ZV are shown in the representation according to FIG. 3 by broken lines from the substitute distributor nodes EV1 to EV5 to the distributor nodes V1 to V5.

If a distributor node V1 to V5 with a group control function fails, it is ensured that the respective annular communication substructure can continue to operate in the constellation with substitute distributor nodes EV1 to EV5. In this case, a substitute distributor node EV1 to EV5 seamlessly takes over the group control function and is in charge of the remaining signal processing units SV of the associated communication substructure. With the aid of the additional connections ZV, the respectively failed distributor node V1 to V5 is bridged.

The data transmission system of the present invention may be configured with a wide variety of bus technologies. For industrial applications, a field bus system, which can meet high requirements in terms of system reliability, would be suitable. Ethernet and Ethernet-related bus technologies would also be suitable as the bus system.

Accordingly, the present invention as disclosed herein, provides a significant increase in the flexibility and availability of machine tools and production machines, and also of robots, in a particularly simple way by a signal return R1 to R6.

1. A data transmission system for machine tools, production machines, and robots comprising a central data line, having branch off stub-like data lines in which signal processing units are arranged, further comprising transmitting and receiving elements which respectively pass on data in a serial form, wherein a return from the last to the first signal processing unit of the stub-like data line is provided.

2. A data transmission system for machine tools, production machines, and robots, comprising a central data line, having branch off stub-like data lines in which signal processing units are arranged, further comprising transmitting and receiving elements which respectively pass on data in a serial form, a return from the last to the first signal processing unit of the central data line is provided.

3. The data transmission system according to claims 1 and 2, wherein a first signal processing unit is designed as a distributor node having a group control function.

4. The data transmission system according to claim 3, wherein a substitute distributor node is incorporated in an annular communication structure.

5. The data transmission system according to claims 1 and 2, wherein a field bus system is provided as the data transmission system.

6. The data transmission system according to claims 1 and 2, wherein an Ethernet is provided as the data transmission system.
